(19) United States
(12) Patent Application Publication
(10) Pub. No.: US 2024/0289637 A1
(43) Pub. Date: Aug. 29, 2024

(54) FEDERATED REPRESENTATION LEARNING WITH CONSISTENCY REGULARIZATION

(71) Applicant: Bayer Aktiengesellschaft, Leverkusen (DE)

(72) Inventors: Matthias LENGA, Kiel (DE); Johannes HÖHNE, Oranienburg (DE); Steffen VOGLER, Berlin (DE)

(73) Assignee: Bayer Aktiengesellschaft, Leverkusen (DE)

(21) Appl. No.: 18/573,793

(22) PCT Filed: Jun. 17, 2022
(86) PCT No.: PCT/EP2022/066541

§ 371 Date: Dec. 22, 2023

(30) Foreign Application Priority Data
Jun. 25, 2021 (EP) 21181802.6

(51) Int. Cl. G06N 3/098

(52) U.S. Cl. CPC G06N 3/098

(57) ABSTRACT

The present invention relates to the technical field of federated learning. Subject matter of the present invention is a method for (re-)training a federated learning system, a computer system for carrying out the method, and a non-transitory computer-readable storage medium comprising processor-executable instructions with which to perform an operation for (re-)training a federated learning system.

### CROSS-REFERENCE TO RELATED APPLICATIONS

This application is a national stage application under 35 U.S.C. § 371 of International Application No. PCT/EP2022/066541, filed internationally on Jun. 17, 2022, which claims the benefit of priority to European Application No. 21181802.6, filed Jun. 25, 2021.

### FIELD

The present invention relates to the technical field of federated learning.

### BACKGROUND

Federated learning is a machine learning approach that can be used to train a machine learning model across a federation of decentralized edge devices, each holding a local data set. Modern federated learning methods typically do not rely on exchanging any training data. It is sufficient to share gradient information or model versions which are locally updated on the edge devices across the federation. Hence, federated learning enables multiple actors to build a common machine learning model without sharing training data, thus allowing to address critical issues such as data privacy, data security, data access rights and access to heterogeneous data.

A typical challenge encountered when applying federated learning methods in real-world practice is that datasets locally stored on the edge devices are typically heterogeneous and their sizes may span several orders of magnitude. This often makes a straightforward application of standard federated learning techniques which aim to train a single global model infeasible.

### SUMMARY

To resolve this issue, the present invention provides a federated learning scheme which can be used to train a global embedding along with local task specific networks.

Therefore, the present invention provides, in a first aspect, a computer system comprising a plurality of edge devices,
wherein each edge device has access to a shared global model, wherein the shared global model is configured to generate a feature vector, at least partially on the basis of input data provided by the edge device and on the basis of global model parameters,
wherein each edge device comprises a task performing model which is configured to receive the feature vector generated by the shared global model on the basis of the input data provided by the edge device, and to perform a task, at least partially on the basis of the feature vector and on the basis of task performing model parameters,
wherein the computer system is configured to perform a training or a re-training, the training or re-training comprising the steps
   receiving a new set of training data for a first edge device, the first edge device comprising a first task performing model which is configured to perform a first task, at least partially on the basis of first task performing model parameters,
   training the shared global model and the first task performing model on the basis of the training data, the training comprising the step of modifying the global model parameters and the first task performing model parameters so that a loss value calculated from a loss function is minimized, the loss function,
      rewarding modifications of the first task performing model parameters and the global model parameters which lead to an improved performance of the first task, and
      rewarding modifications of the global model parameters which lead to an improvement of the shared global model, and
      penalizing modifications of the global model parameters which lead to a worse performance of tasks performed by other task performing models of other edge devices of the plurality of edge devices.

The present invention further provides a computer-implemented method of training or re-training a federated learning system, the method comprising the steps of
providing a federated learning system comprising at least two edge devices, a first edge device and a second edge device,
   wherein the first edge device and the second edge device have access to a shared global model, wherein the shared global model is configured to generate a feature vector, at least partially on the basis of input data provided by the first edge device or the second edge device and on the basis of global model parameters,
   wherein the first edge device comprises a first task performing model, wherein the first task performing model is configured to perform a first task, at least partially on the basis of the feature vector generated by the shared global model on the basis of the input data provided by the first edge device and on the basis of first task performing model parameters,
   wherein the second edge device comprises a second task performing model, wherein the second task performing model is configured to perform a second task, at least partially on the basis of the feature vector generated by the shared global model on the basis of the input data provided by the second edge device and on the basis of second task performing model parameters,
training or re-training of the federated learning system, wherein the training or re-training comprises
   inputting first input data into the shared global model, and receiving a first feature vector,
   inputting the first feature vector into the first task performing model and receiving a first task result,
   inputting second input data into the shared global model, and receiving a second feature vector,
   inputting the second feature vector into the second task performing model and receiving a second task result,
   calculating a loss value by using a loss function, the loss function
      rewarding modifications of the first task performing model parameters and the global model parameters which lead to an improved performance of the first task, and
      rewarding modifications of the global model parameters which lead to an improvement of the shared global model, and
      penalizing modifications of the global model parameters which lead to a worse performance of the second task,
   modifying the first task performing model parameters and the global model parameters, based, at least partially, on minimizing the loss value.

The present invention further provides a non-transitory computer-readable storage medium comprising processor-executable instructions with which to perform an operation for training or re-training a federated learning system, the federated learning system comprising at least two edge devices, a first edge device and a second edge device,
wherein the first edge device and the second edge device have access to a shared global model, wherein the shared global model is configured to generate a feature vector, at least partially on the basis of input data provided by the first edge device or by the second edge device and on the basis of global model parameters,
wherein the first edge device comprises a first task performing model, wherein the first task performing model is configured to perform a first task, at least partially on the basis of the feature vector generated by the shared global model on the basis of the input data provided by the first edge device and on the basis of first task performing model parameters,
wherein the second edge device comprises a second task performing model, wherein the second task performing model is configured to perform a second task, at least partially on the basis of the feature vector generated by the shared global model on the basis of the input data provided by the second edge device and on the basis of second task performing model parameters,
   the operation comprising:
inputting first input data into the shared global model, and receiving a first feature vector,
inputting the first feature vector into the first task performing model and receiving a first task result,
inputting second input data into the shared global model, and receiving a second feature vector,
inputting the second feature vector into the second task performing model and receiving a second task result,
calculating a loss value by using a loss function, the loss function
   rewarding modifications of the first task performing model parameters and the global model parameters which lead to an improved performance of the first task, and
   rewarding modifications of the global model parameters which lead to an improvement of the shared global model, and
   penalizing modifications of the global model parameters which lead to a worse performance of the second task,
modifying the first task performing model parameters and the global model parameters, based, at least partially, on minimizing the loss value.

A further aspect of the present invention relates to the use of the computer system, as defined above, or of the computer-readable storage medium, as defined above, for medical purposes, in particular for performing tasks on medical images of patients.

### BRIEF DESCRIPTION OF THE FIGURES

Additional advantages and details of non-limiting embodiments are explained in greater detail below with reference to the exemplary embodiments that are illustrated in the accompanying schematic figures, in which:

FIG. 1 shows schematically an embodiment of a computer system according to the present invention.

FIG. 2 shows schematically another embodiment of a computer system according to the present invention.

FIG. 3 shows schematically an example of a centralized federal learning system.

FIG. 4 shows by way of example how input data for performing a first ask are inputted into the shared global model.

FIG. 5 shows schematically by way of example the learning setup for (re-)training the task performing model on one of the edge devices.

FIG. 6 shows schematically by way of example a federated learning system comprising a number n of edge devices.

FIG. 7 shows a federated learning system comprising a central server, a first edge device, a second edge device, and a third edge device.

FIG. 8 illustrates a computing device according to some example implementations of the present invention in more detail.

### DETAILED DESCRIPTION

The invention will be more particularly elucidated below without distinguishing between the subjects of the invention (method, computer system, computer-readable storage medium). On the contrary, the following elucidations are intended to apply analogously to all the subjects of the invention, irrespective of in which context (method, computer system, computer-readable storage medium) they occur.

If steps are stated in an order in the present description or in the claims, this does not

necessarily mean that the invention is restricted to the stated order. On the contrary, it is conceivable that the steps can also be executed in a different order or else in parallel to one another, unless one step builds upon another step, this absolutely requiring that the building step be executed subsequently (this being, however, clear in the individual case). The stated orders are thus preferred embodiments of the invention.

The computer system according to the present invention comprises a plurality of edge devices, sometimes also referred to as nodes. The term “plurality” means any number greater than 1, e.g. 2, 3, 4, 5, 6, 7, 8, 9, 10 or any other number higher than 10.

The computer system according to the present invention can comprise a central server. Such a central server can orchestrate the distribution of models and/or parameters across the federation, trigger the timepoints of (re-)training and execute global model updates e.g. via a scheduler module. Such a computer system may be referred to as a centralized federated learning system. If a central server is present, usually each edge device is communicatively connected to the central server in order to receive data from the central server and/or to send data to the central server.

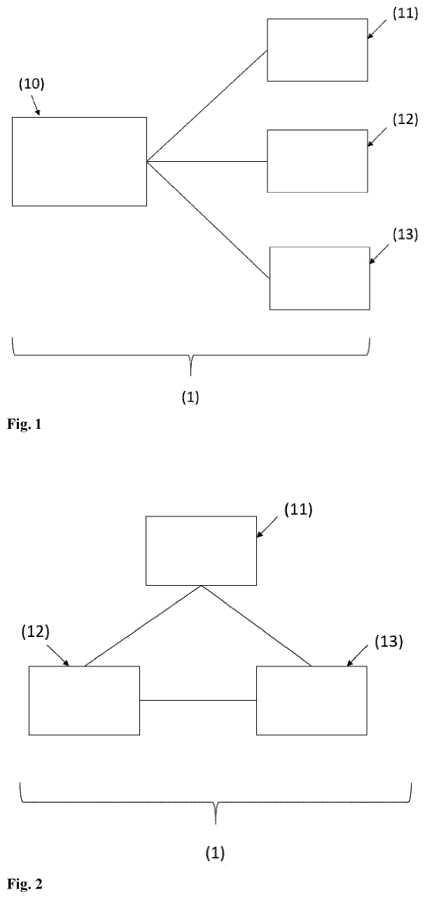

FIG. 1 shows schematically an embodiment of a computer system according to the present invention. The computer system depicted in FIG. 1 is an example of a centralized federated learning system. The computer system (1) comprises a central server (10), and three edge devices: a first edge device (11), a second edge device (12), and a third edge device (13). Each edge device is communicatively connected to the central server (10).

It is also possible to use a decentralized federated learning setting for executing the present invention. In such a decentralized federated learning setting, the edge devices are able to coordinate themselves to obtain and update the global model. Preferably, each edge device is communicatively connected to each other edge device in order to share (receive and/or transmit) data between the edge devices.

FIG. 2 shows schematically another embodiment of a computer system according to the present invention. The computer system depicted in FIG. 2 is an example of a decentralized federated learning system. The computer system (1) comprises three edge devices: a first edge device (11), a second edge device (12), and a third edge device (13). The edge devices are communicatively connected to each other.

Mixed settings comprising a central server, one or more first type edge devices and one or more second type edge devices are also conceivable. In such a mixed setting, the first type edge devices are connected to the central server, and the second type edge devices are connected to at least one first type edge device and optionally connected to other second type edge devices.

It is also possible to realize the invention by setting up a computer system comprising some messaging-oriented middleware to handle the communication between the devices.

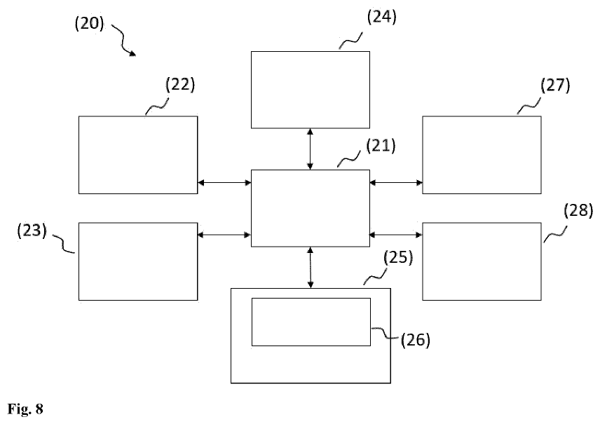

The central server (if present) as well as each edge device is a computing device comprising a processing unit connected to a memory (see in particular FIG. 8 and the parts of this description related thereto).

Each edge device has access to a shared global model. As the term “shared global model” suggests, the edge devices have access to the same global model. It is possible, that there is more than one shared global model, e.g. different shared global models for different purposes/applications (e.g. for performing different tasks).

Usually, each edge device comprises a copy of the global model and can receive from the central server (if present) or another edge device an updated global model if such an update is available.

The shared global model (herein also referred to as global model for short) can be loaded into a memory of an edge device and/or the central server and can be used to generate, at least partially on the basis of input data and on the basis of a set of global model parameters, a feature vector, also referred to as (global) embedding.

Usually, each edge device is configured to feed (local) input data into the shared global model and receive, as an output from the shared global model, a feature vector. The term “local” means that the input data are only available for a respective edge device and are not shared between edge devices and/or not shared with the central server (if present). However, it is in principle possible that two or more edge devices share, at least partially, some input data.

The feature vector can be used by the respective edge device for performing a task. Each edge device can be configured to perform a different task or some or all of the edge devices can be configured to perform the same task. Usually, there are at least two edge devices that perform a different task. It is also possible that one or more edge devices are configured to perform more than one task on the basis of one or more feature vector(s).

FIG. 3 shows schematically an example of a centralized federal learning system (1) comprising a central server (10), and three edge devices: a first edge device (11), a second edge device (12), and a third edge device (13). The first edge device (11) is configured to perform a first task T(1), a second task T(2), and a third task T(3). The second edge device (12) is configured to perform a fourth task T(4). The third edge device (13) is configured to perform the second task T(2), and a fifth task T(5). So, both, the first edge device (11) and the third edge device (13) are configured to perform the same task T(2).

For performing a task, a task performing model is used. The task performing model can be loaded into a memory of an edge device. The edge device is configured to input a feature vector generated by the shared global model into a task performing model. The task performing model then generates a task result. Performing a task means generating a task result.

Each task is performed, at least partially, on the basis of task performance model parameters.

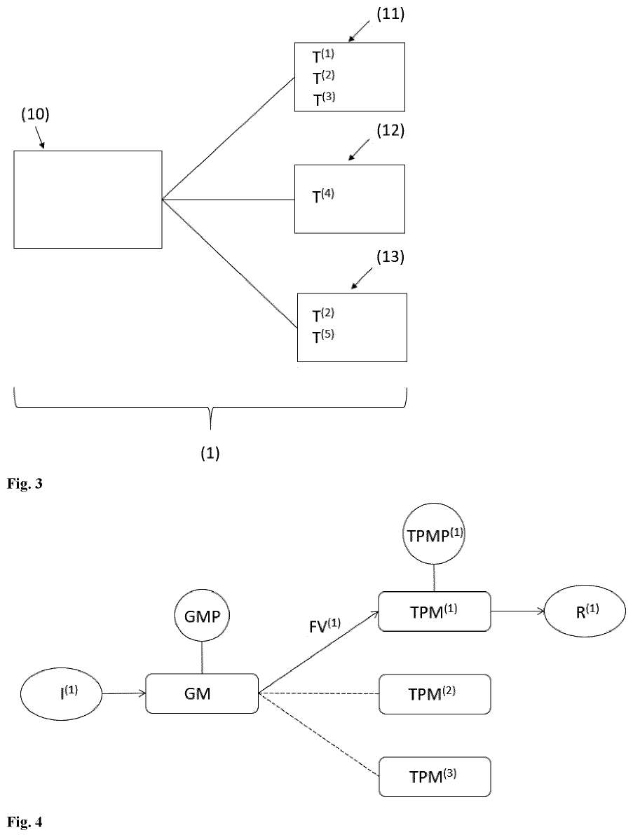

As already described, the process of performing a task can be separated into two steps: in a first step (local) input data are inputted into the shared global model which is configured to generate a feature vector, and in a second step, the feature vector is inputted into a task performing model which is configured to perform a specific task. This two-step approach is schematically depicted in FIG. 4. FIG. 4 shows by way of example how input data I(1) for performing a first ask are inputted into the shared global model GM. The shared global model GM generates a feature vector FV(1) on the basis of the input data I(1) and on the basis of shared global model parameters GMP. The task performing model TPM(1) then takes the feature vector FV(1) as an input and generated a task result R(1). The generation of the task result R(1) is, at least partially, based on the feature vector FV(1) and on the task performance model parameters TPMP(1).

A task can be any task which can be performed by a machine learning model, such as a classification task, a regression task, a reconstruction task, an image segmentation task etc. Further examples of tasks are given below.

Each task performing model, as well as the shared global model, is usually a machine learning model.

Such a machine learning model, as used herein, may be understood as a computer implemented data processing architecture. The machine learning model can receive input data and provide output data based on that input data and the machine learning model, in particular the parameters of the machine learning model. The machine learning model can learn a relation between input and output data through training. In training, parameters of the machine learning model may be adjusted in order to provide a desired output for a given input.

A machine learning model can e.g. be or comprise an artificial neural network. An artificial neural network (ANN) is a biologically inspired computational model. An ANN usually comprises at least three layers of processing elements: a first layer with input neurons, an Nth layer with at least one output neuron, and N−2 inner layers, where N is a natural number greater than 2. In such a network, the input neurons serve to receive the input data. The output neurons serve to generate an output, e.g. a result. The processing elements of the layers are interconnected in a predetermined pattern with predetermined connection weights therebetween. Each network node can represent a calculation of the weighted sum of inputs from prior nodes and a non-linear output function. The combined calculation of the network nodes relates the inputs to the outputs.

Before a task performing model can perform a task, it must be trained. The process of training a machine learning model involves providing a machine learning algorithm (that is the learning algorithm) with training data to learn from. The term trained machine learning model refers to the model artifact that is created by the training process. The shared global model and/or each task performing model is/are usually the result of a training process.

The training data must contain the correct answer, which is referred to as the target. The learning algorithm finds patterns in the training data that map input data to the target, and it outputs a machine learning model that captures these patterns.

The trained machine learning model can be used to get predictions on new data for which the target is not (yet) known.

For each task to be performed the shared global model and the respective task performing model usually constitute a (trained or to be trained) machine learning model.

In the training process, training data are inputted into the machine learning model and the machine learning model generates an output. The output is compared with the (known) target. Parameters of the machine learning model are modified in order to reduce the deviations between the output and the (known) target to a (defined) minimum. In other words: during training, model parameters are modified in a way that minimizes the deviations between the output and the (known) target. For clarification: minimizing does not mean that a global minimum (no deviations between output and target) must be achieved. Depending on the specific application and the requirements of the application on the accuracy of the model, it can be sufficient for a model to reach a local minimum or a defined (acceptable) deviation.

In general, a loss function can be used for training to evaluate the machine learning model. For example, a loss function can include a metric of comparison of the output and the target. The loss function may be chosen in such a way that it rewards a wanted relation between output and target and/or penalizes an unwanted relation between an output and a target. Such a relation can be e.g. a similarity, or a dissimilarity, or another relation.

A loss function can be used to calculate a loss value for a given pair of output and target. The aim of the training process can be to modify (adjust) parameters of the machine learning model in order to reduce the loss value to a (defined) minimum.

A loss function may for example quantify the deviation between the output of the machine learning model for a given input and the target. If, for example, the output and the target are numbers, the loss function could be the difference between these numbers, or alternatively the absolute value of the difference. In this case, a high absolute value of the loss function can mean that a parameter of the model needs to undergo a strong change.

In the case of a scalar output, a loss function may be a difference metric such as an absolute value of a difference, a squared difference.

In the case of vector-valued outputs, for example, difference metrics between vectors such as the root mean square error, a cosine distance, a norm of the difference vector such as a Euclidean distance, a Chebyshev distance, an Lp-norm of a difference vector, a weighted norm or any other type of difference metric of two vectors can be chosen. These two vectors may for example be the desired output (target) and the actual output.

In the case of higher dimensional outputs, such as two-dimensional, three-dimensional or higher-dimensional outputs, for example an element-wise difference metric can be used. Alternatively or additionally, the output data may be transformed, for example to a one-dimensional vector, before computing a loss function.

The term “re-training” as it is used herein refers to re-running the process that generated the trained machine learning model on a new training set of data. The term “(re-)training” means training or re-training.

The re-training of the federated learning system according to the present invention is hereinafter explained in more detail. For the sake of simplicity, it is assumed that the computer system according to the present invention comprises a plurality of edge devices, each edge device being configured to perform a single specific task. Each specific task is performed using a machine learning model, each machine learning model comprising the shared global model and a specific task performing model. It is further assumed that each machine learning model is already trained. It is further assumed that on one of the edge devices, new (local) input data are available which can be used to re-train the machine learning model on that edge device, e.g. in order to improve the machine learning model (e.g. to obtain a higher accuracy, wider application possibilities and/or the like). The edge device for which new (local) data are available is referred to as the first edge device. Accordingly, the task performing model used by the first edge device for performing a task is referred to as the first task performing model, and the task to be performed is referred to as the first task. Another edge device of the computer system according to the present invention is referred to as the second edge device; the task performing model used by the second edge device for performing a task is referred to as the second task performing model, and the respective task to be performed is referred to as the second task.

If the machine learning model of the first edge device is re-trained, the re-training may lead to changes of the parameters of the shared global model (the global model parameters). A change of the global model parameters may influence the quality of other machine learning models (e.g. of other edge devices) since other edge devices make also use of the shared global model. In other words: changes of the shared global model caused by re-training the model of the first edge device may cause unwanted effects for the model of the second edge device. In order to prevent changes of the shared global model which lead to unintentional consequences for the machine learning models (e.g. of other edge devices), a specific loss function is used for re-training.

A loss function is used which ensures that
modifications of the first task performing model parameters and the global model parameters which lead to an improved performance of the first task are rewarded,
modifications of the global model parameters which lead to an improved quality of the shared global model are rewarded,
modifications of the global model parameters which lead to worse performance of the second task are penalized.

So, during the re-training process it is ensured that the shared global model is not dominated by a model of one of the edge devices. Modifications of the global model parameters-that usually have an influence on the performance of each task on each edge device-are only allowed as long as the positive effects on the performance of some tasks and/or the quality of the global mode overweigh any negative effects on the performance of the other tasks.

The quality of the shared global model and the determination of whether a modification of global model parameters leads to an improvement or to a deterioration of the shared global model can be determined by e.g. calculating a reconstruction loss. The shared global model can be e.g. set up as an encoder-decoder type neural network. The encoder is configured to receive input data and generate, at least partially on the basis of global model parameters, a feature vector from the input data. The decoder is configured to reconstruct, at least partially on the basis of global model parameters, the input data from the feature vector. The reconstruction loss function evaluates the deviations between the input data and the reconstructed input data. The aim of the training is to minimize the deviations between the input data and the reconstructed input data by minimizing the loss function. Regularization techniques can be used to prevent overfitting.

In a preferred embodiment, for (re-)training the shared global model a contrastive learning approach is combined with the reconstruction learning. Such an approach is e.g. described in the following publication, the content of which is incorporated herein in its entirety by reference: J. Dippel, S. Vogler, J. Höhne: Towards Fine-grained Visual Representations by Combining Contrastive Learning with Image Reconstruction and Attention-weighted Pooling, arXiv:2104.04323 [cs.CV].

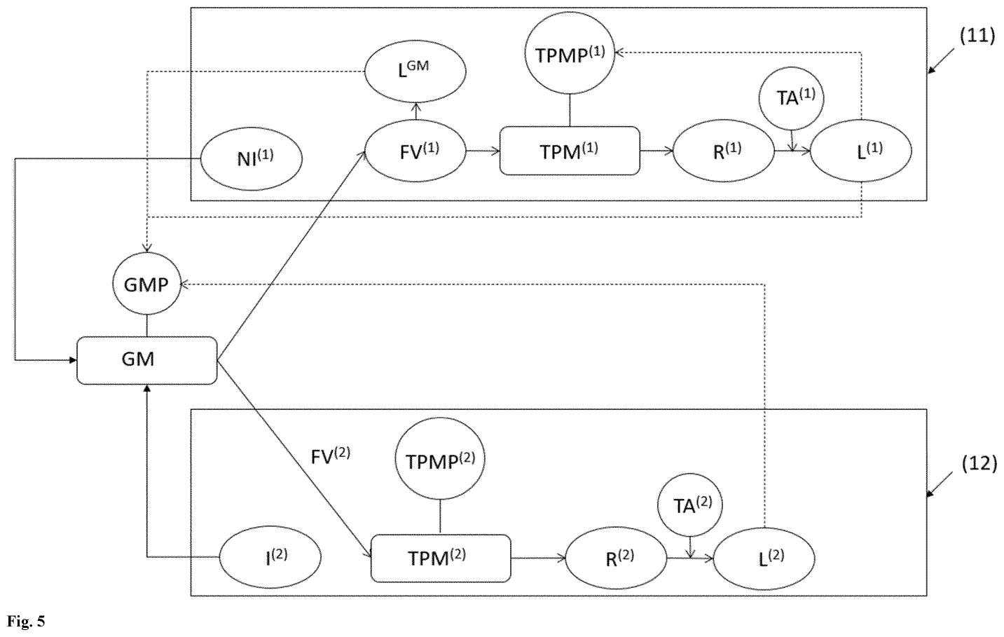

FIG. 5 shows schematically by way of example the learning setup for (re-)training the task performing model on one of the edge devices. In FIG. 5 two edge devices are shown, a first edge device (11) and a second edge device (12). Both edge devices have access to a shared global model GM. The shared global model GM is configured to receive input data and generate a feature vector, at least partially on the basis of global model parameters GMP. The first edge device (11) comprises a first task performing model TPM(1). The first task performing model TPM(1) is configured to receive a feature vector and generate, at least partially on the basis of first task performing model parameters TPMP(1) a first result. The second edge device (12) comprises a second task performing model TPM(2). The second task performing model TPM(2) is configured to receive a feature vector and generate, at least partially on the basis of second task performing model parameters TPMP(2) a second result.

On the first edge device (11) (new) first input data NII are available which can be used to (re-)train the first task performing model TPM(1). For such training purposes, the first input data NI(1) are inputted into the shared global model GM which generates a first feature vector FV(1). The first feature vector FV(1) is inputted into the first task performing model TPM(1) which generates a first result R(1). For the first result R(1) a first loss L(1) is calculated, e.g. by comparing the first result R(1) with a first target TA(1). The first loss L(1) is used to modify the first task performing model parameters TPMP(1) in a way which reduces the first loss L(1). The first loss L(1) is also used to modify the global model parameters GMP in a way which reduces the first loss L(1). However, the aim of the learning setup is not just to minimize the first loss L(1), but also to take care that the quality of the global model is not reduced, and, in addition, that the second edge device which also makes use of the shared global model is still able to perform its task with a defined quality.

Therefore, in a preferred embodiment of the present invention, a feature vector generation loss LGM is calculated as well as a second loss L(2) for the performance of the second task by the second edge device. The feature vector generation loss LGM evaluates the quality of the shared global model to generate a feature vector, e.g. by reconstructing input data from a feature vector and calculating a reconstruction loss. This can e.g. be done on the basis of the (new) first input data NI(1). The second loss L(2) can be determined by inputting second input data I(2) into the shared global model, thereby receiving a second feature vector FV(2) from the shared global model, inputting the second feature vector FV(2) into the second task performing model TPM(2), thereby receiving a second result R(2), and comparing the second result R(2) with a second target TA(2).

A total loss L can be calculated from the first loss L(1), the second loss L(2) and the feature vector generation loss LGM, e.g. by taking the weighted sum:

$$L = α \cdot {L}^{( 1 )} + β \cdot {L}^{( 2 )} + γ \cdot {L}^{G M}$$

α, β and γ are weighting factors which can be used to weight the losses, e.g. to give to a certain loss more weight than to another loss. α, β and γ can be any value greater than zero; usually α, β and γ represent a value greater than zero and smaller or equal to one. In case of α=β=γ=1, each loss is given the same weight. Note, that α, β and γ can vary during the training process.

The process for re-training a task performing model on new training data as described above can also be applied to the integration of a new edge device into an existing FL system. The new edge device can e.g. be connected to the central server from which it receives a copy of the shared global model. A new task performing model can be stored on the new edge device together with training data. Training of the new task performing model can be performed as described above, using a loss function which
rewards modifications of parameters of the new task performing model and the shared global model which lead to an improved performance of the task performed by the new task performing model,
rewards modifications of the global model parameters which lead to an improvement of the shared global model, and penalizes modifications of the global model parameters which lead to a deterioration of the performance of the task performing models stored on the other edge devices.

A new computer system according to the present invention can be set up in a similar manner. The setting up can e.g. start with a first edge device which comprises the general model and a first task performing model. The machine learning system comprising the general model and the first task performing model can be trained, such training comprising modifying parameters of the general model and of the task performing model in a way that reduces deviations between the outcome of the first task performing model and a target. Once the machine learning system is trained, a second edge device comprising a second task performing model can be added to the computer system and trained as described above for the integration of a new edge device. Likewise, it is possible to add a second task performing model to the first edge device and train it as described above for the integration of a new edge device.

In FIG. 5, only two edge devices are shown. Usually, there are more than two edge devices. Usually, there is one edge device for which the task performing model is (re-)trained, and there are a plurality of other edge devices for each of which a loss is calculated in order to evaluate the impact of a modification of global model parameters on the quality of the task to be performed by the respective edge device. These losses are herein also referred to as consistency losses because they serve to ensure consistency of the models used by the edge devices. The second loss L2 as explained in connection with FIG. 5 is an example of such a consistency loss.

It is possible that on each (other) edge device, a set of input data and target data is stored which (solely) serve the purpose of calculating the consistency loss. Such set of input data and target data is herein also referred to as consistency data set. With the aid of the consistency data it is ensured that there are no modifications made to the global model parameters which result in a (significant) deterioration of the task performed by another task performing model. The consistency data can be a comparatively small set of data (in comparison to a set of training data required for a full training of a model). Only a small set of data is required in order to evaluate whether any modification of global model parameters will result in a (significant) deterioration of a task performing model which is not (re-)trained in a training session. The evaluation is done by inputting the input data of the consistency data into the shared global model, thereby receiving a feature vector, inputting the feature vector into the task performing model under evaluation, thereby receiving an output (a result), comparing the output with the target data of the consistency data, and determining the deviations between output and target data.

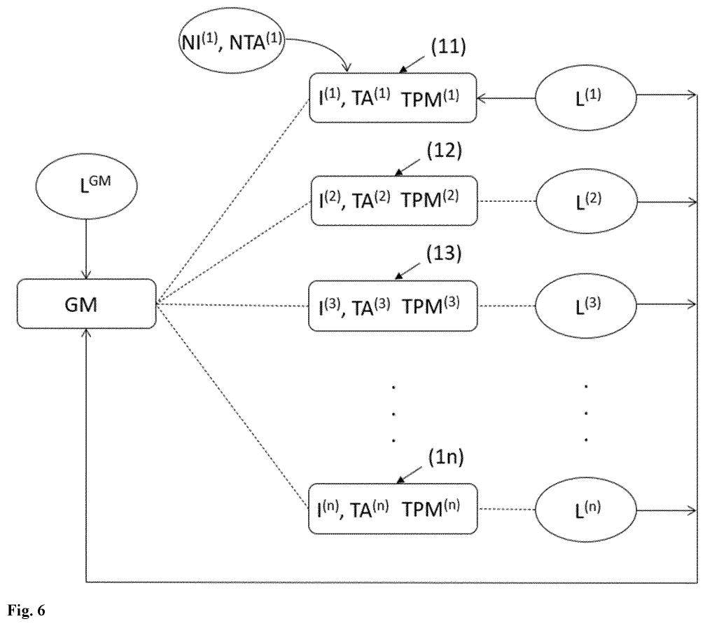

FIG. 6 shows schematically by way of example a federated learning system comprising a number n of edge devices (11), (12), (13), . . . , (1n). Each edge device has access to a shared global model (GM). On each edge device a consistency data set comprising consistency input data and consistency target data is stored: on the first edge device (11) the consistency data set comprises first consistency input data I(1) and first consistency target data TA(1), on the second edge device (12) the consistency data set comprises second consistency input data I(2) and second consistency target data TA(2), and so forth. On each edge device, there is a task performing model which is configured to perform a task: on the first edge device (11) there is a first task performing model TPM(1), on the second edge device (12) there is a second task performing model TPM(2), and so forth. In the example depicted in FIG. 6, a new data set NI(1), NTA(1) becomes available for the first edge device (11). The aim is to (re-)train particularly the first task performing model TPM(1) on the basis of the newly available data set. On the basis of the newly available data set, a first loss L(1) is calculated which quantifies the impact of modifications of parameters of the shared global model and of the first task performing model on the performance of the first task. A feature vector generation loss LGM is calculated which evaluates the impact of modifications of parameters of the shared global model on the quality of the shared global model. On each edge device other than the first edge device, a consistency loss is calculated on the basis of the respective consistency data set, each consistency loss evaluating the impact of modifications of the global model parameters on the quality of the task performed by the respective edge device (on the consistency dataset). A total loss is calculated using a loss function which
rewards modifications of the global model parameters which lead to an improved quality of the shared global model,
rewards modifications of the first task performing model parameters and the global model parameters which lead to an improved performance of the first edge device in performing its task, and
penalizes modifications of the global model parameters which lead to worse performance of the other edge devices in performing their tasks (on the consistency dataset).

The total loss is based on the first loss, the feature vector generation loss and all consistency losses.

The loss function is described by way of example in more detail below wherein some assumptions are made. It is emphasized that the assumptions are for simplicity; it is not intended to limit the invention to these assumptions. In addition, any features characterizing an embodiment of the present invention and mentioned herein can in principle be combined with any other feature(s) mentioned herein. So, the present invention should cover any combination of one or more features mentioned herein.

Assumptions:
The federated learning system comprises a central server and a number n of edge devices E⁽¹⁾, . . E⁽ⁿ⁾ wherein n is an integer greater than 1.
Each edge device comprises one task performing model.
Each task performing model (also referred to as task head) is implemented as an artificial neural network which is configured to receive a feature vector from the shared global model and to perform a task on the feature vector. The input dimension of each task performing model corresponds to the dimension of the feature vector. H⁽¹⁾, . . . , H⁽ⁿ⁾ represent the operations which are applied by the respective task performing model to the feature vector. The result (outcome, output) of each task performing model is a result R.
On each edge device a consistency data set is stored, each consistency data set comprising consistency input data I and consistency target data TA.
The shared global model is implemented as an encoder-decoder type neural network which is configured to generate a feature vector (an embedding) from input data (encoder part) and to reconstruct the input data from the feature vector (decoder part). Φ represents the operation which is applied to the input data by the shared global model.
A central server stores the current version of all models Φ, H⁽¹⁾, . . . , H⁽ⁿ⁾. In case a training process is triggered, the server validates that all edge devices hold the latest versions of the models they require, and the server sends updates if needed.
For edge device E^{(k)} new input data NI^{(k)} and target data NTA^{(k)} are available which can be used for (re-)training purposes, where 1≤k≤n.

Based on the assumptions listed above, a (re-)training iteration is triggered.

For each edge device E^{(j)} for which no new data are available, a consistency target CTA^{(j)} is calculated using the consistency data I^{(j)} locally available on the respective edge device, wherein j is an index with j≠k:

$${CTA}^{( j )} = {H}^{( j )} ∘ Φ ( {I}^{( j )} )$$

Training is performed on the basis of the following loss function:

$$\begin{matrix}{L}_{θ , {θ}^{( k )}}^{( k )} ( {I}^{( k )} , {R}^{( j )} ) = α \cdot {L}^{GM} ( {Φ}_{θ} ( {NI}^{( k )} ) , {NI}^{( k )} ) \\ + β \cdot {L}^{( k )} ( {H}_{{θ}^{( k )}}^{( k )} ∘ {Φ}_{θ} ( {NI}^{( k )} , {TA}^{( k )} ) \\ + γ \cdot {\sum }_{j \neq k} d ( {H}^{( j ) ∘} {Φ}_{θ} ( {I}^{( j )} ) , {CT}^{( j )} )\end{matrix}$$

in which:
α, β and γ are weighting factors which can be used to weight the losses (as already explained above).,
θ represents the set of parameters of the global model Φ_{θ},
θ^{(k)} represent the set of model parameters of the task head H^{(k)},
wherein the model parameters θ and θ^{(k)} can be modified during training, and
d denotes an appropriate metric/loss function that penalizes the deviation of the model H^{(j)}·Φ_{θ}(I^{(j)}) from the consistency target CTA^{(j)}.

Each consistency target CTA^{(j)} records the behavior of the task heads H^{(j)} on the local data prior to any local update of the models H^{(k)} and Φ. Hence, the regularization term in the last line introduces a bias towards parameter updates of the embedding Φ that keep the behavior of the task heads H^{(k)} (j≠k) consistent on the local data.

Additional (weighted) losses can be added e.g. for regularization purposes.

In a next step, the loss function L_{θ,θ}_{^{(k)}}^{(k)}(I^{(k)} (I^{(k)}, R^{(j)}) is minimized with respect to the parameters (θ, θ^{(k)}).

In case that the loss function L_{θ,θ}_{^{(k)}}^{(k)}(I^{(k)}, R^{(j)}) is differentiable with respect to (θ, θ^{(k)}), gradient descent methods can be used to minimize the loss. To that end , a local gradient ∇(θ,θ^{(k)}, L_{θ,θ}_{^{(k)}}^{(k)}(I^{(k)} (I^{(k)}, R^{(j)})) can be calculated, and the models can be updated.

Please note that the task head H^{(k)} is only updated on the corresponding edge device E(k). In other words, in this proposed update scheme the model parameters θ^{(j)} for j≠k are not affected by the minimization step described above. The global embedding Φ is updated on all edge devices. The model updates related to Φ can be aggregated using a standard Federated Learning model weight update scheme (e.g. FedAvg, see e.g. arXiv: 1907.02189 [stat.ML]). At the end of the training iteration all updated models can be stored centrally on the central server.

The description above certainly does not cover all embodiments/variations of the present invention. For example:
In this implementation it was assumed that a central server stores the current versions of all models Φ, H⁽¹⁾, . . . , H⁽ⁿ⁾. Clearly, other embodiments covering decentral implementations are possible.
Besides the consistency target regularization technique there exist other options how a consistency-bias can be introduced into the loss functional (e.g. projection techniques, elastic weight consolidation, . . . )
A training scheme alternating between updates of the global model Φ and updates of the local task heads H⁽¹⁾, . . . , H⁽ⁿ⁾ can introduce additional stability during training.

Once, the federated learning system comprising at least one shared global model and a plurality of task performing models is (re-)trained, it can be stored (e.g. on a central server and/or on each edge device) and used for performing tasks on new input data.

Preferred embodiments of the present invention are:

1. A computer system comprising a plurality of edge devices,
wherein each edge device has access to a shared global model, wherein the shared global model is configured to generate a feature vector, at least partially on the basis of input data and on the basis of global model parameters,
wherein each edge device comprises a task performing model which is configured to receive a feature vector and to perform a task, at least partially on the basis of the feature vector and on the basis of task performing model parameters,
wherein the computer system is configured to perform a (re-)training, the (re-)training comprising the steps
   receiving a new set of training data for a first edge device, the first edge device comprising a first task performing model which is configured to perform a first task, at least partially on the basis of first task performing model parameters and on the basis of a feature vector provided by the shared global model,
   training the shared global model and the first task performing model on the basis of the training data, the training comprising the step of modifying the global model parameters and the first task performing model parameters so that a loss value calculated from a loss function is minimized, the loss function
      rewarding modifications of the first task performing model parameters and the global model parameters which lead to an improved performance of the first task
      rewarding modification of the global model parameters which lead to an improvement of the shared global model
      penalizing modifications of the global model parameters which lead to a worse performance of the tasks performed by other task performing models.
         2. The computer system according to embodiment 1, wherein the computer system comprises a central server, wherein a copy of the shared global model is stored on the central server and on each edge device, wherein the central server is configured to update the shared global model on each edge device if an updated version is available.
         3. The computer system according to embodiment 1 or 2, wherein there are at least two edge devices which comprise different task performing models to perform different tasks.
         4. The computer system according to any one of the embodiments 1 to 3, wherein the tasks performed by the task performing models are selected from: classification task, regression task, data generation task, image segmentation task, reconstruction task, image quality enhancement task and/or combinations thereof.
         5. The computer system according to any one of the embodiments 1 to 4, wherein each model is or comprises a machine learning model based on an artificial neural network.
         6. The computer system according to any one of the embodiments 1 to 5, wherein the shared global model is or comprises an encoder-decoder architecture, the encoder being configured to generate a feature vector from input data and the decoder being configured to reconstruct input data from a feature vector.
         7. The computer system according to any one of the embodiments 1 to 6, wherein on each edge device a consistency data set is stored, each consistency data set comprising consistency input data and consistency target data, wherein the (re-)training comprises the following steps:
computing a first loss value L⁽¹⁾, the first loss value L⁽¹⁾ quantifying the impact of modifications of the global model parameters and of the first task performing model parameters on the performance of the first task,
computing a feature generation loss value LGM, the feature generation loss value LGM quantifying the impact of modifications of the global model parameters on the quality of the feature vector generation,
for each edge device E^{(j)} other than the first edge device:
   inputting the consistency input data into the shared global model,
   receiving from the shared global model a feature vector,
   inputting the feature vector into the task performing model stored on the edge device,
   receiving a result from the task performing model,
   computing, at least partially on the basis of the received result and the consistency target data, a consistency loss L^{(j)}, the consistency loss quantifying the impact of modifications of the global model parameters on the deviations between the result and the consistency target,
computing a total loss value L from the feature generation loss value LGM, the first loss value L⁽¹⁾ and all consistency losses L^{(j)},
modifying the global model parameters and the first task performing model parameters so that the total loss value L is minimized.
   8. A method of (re-)training a federated learning system, the method comprising the steps of
providing a federated learning system comprising at least two edge devices, a first edge device and a second edge device,
wherein the first edge device and the second edge device have access to a shared global model, wherein the shared global model is configured to generate a feature vector, at least partially on the basis of input data and on the basis of global model parameters,
wherein the first edge device comprises a first task performing model, wherein the first task performing model is configured to perform a first task, at least partially on the basis of a feature vector and on the basis of first task performing model parameters,
wherein the second edge device comprises a second task performing model, wherein the second task performing model is configured to perform a second task, at least partially on the basis of a feature vector and on the basis of second task performing model parameters,
   (re-)training of the federated learning system, wherein the (re-)training comprises
inputting first input data into the shared global model, and receiving a first feature vector
inputting the first feature vector into the first task performing model and receiving a first task result
inputting second input data into the shared global model, and receiving a second feature vector
inputting the second feature vector into the second task performing model and receiving a second task result
calculating a loss value by using a loss function, the loss function
   rewarding modifications of the first task performing model parameters and the global model parameters which lead to an improved performance of the first task
   rewarding modifications of the global model parameters which lead to an improvement of the shared global model
   penalizing modifications of the global model parameters which lead to a worse performance of the second task
modifying the first task performing model parameters and the global model parameters, based, at least partially, on minimizing the loss value.
   9. The method according to embodiment 8, wherein the first task performance model is configured to perform a different task than the second task performing model.
   10. The method according to embodiment 8 or 9, wherein a consistency data set is stored on the second edge device, the consistency data set comprising consistency input data and consistency target data, wherein the (re-)training comprises the following steps:
receiving new training data for the first edge device, the new training data comprising first input data and first target data,
inputting the first input data into the shared global model, and receiving a first feature vector,
inputting the first feature vector into the first task performing model and receiving a first task result,
calculating a first loss value, the first loss value quantifying the deviations between the first task result and the first target data,
inputting the consistency input data into the shared global model, and receiving a second feature vector,
inputting the second feature vector into the second task performing model and receiving a second task result,
calculating a second loss value, the second loss value quantifying the deviations between the second task result and the consistency target data,
reconstructing the first input data from the first feature vector using the shared global model,
calculating a third loss value, the third loss value quantifying the deviations between the first input data and the reconstructed first input data,
calculating a total loss value on the basis of the first loss value, the second loss value and the third loss value,
modifying the first task performing model parameters and the global model parameters, based, at least partially, on minimizing the total loss value.
   11. A non-transitory computer-readable storage medium comprising processor-executable instructions with which to perform an operation for (re-)training a federated learning system, the federated learning system comprising at least two edge devices, a first edge device and a second edge device,
wherein the first edge device and the second edge device have access to a shared global model, wherein the shared global model is configured to generate a feature vector, at least partially on the basis of input data and on the basis of global model parameters,
wherein the first edge device comprises a first task performing model, wherein the first task performing model is configured to perform a first task, at least partially on the basis of a feature vector and on the basis of first task performing model parameters,
wherein the second edge device comprises a second task performing model, wherein the second task performing model is configured to perform a second task, at least partially on the basis of a feature vector and on the basis of second task performing model parameters,
   the operation comprising:
inputting first input data into the shared global model, and receiving a first feature vector inputting the first feature vector into the first task performing model and receiving a first task result
inputting second input data into the shared global model, and receiving a second feature vector
inputting the second feature vector into the second task performing model and receiving a second task result
calculating a loss value by using a loss function, the loss function
   rewarding modifications of the first task performing model parameters and the global model parameters which lead to an improved performance of the first task
   rewarding modifications of the global model parameters which lead to an improvement of the shared global model
   penalizing modifications of the global model parameters which lead to a worse performance of the second task
modifying the first task performing model parameters and the global model parameters, based, at least partially, on minimizing the loss value.

In a preferred embodiment of the present invention, the data which are used for training, re-training, and performing tasks are personal data, preferably medical data related to one or more (human) patients (e.g. health information).

To name a few non-limiting examples, the data can pertain to internal body parameters such as blood type, blood pressure, cholestenone, resting heart rate, heart rate variability, vagus nerve tone, hematocrit, sugar concentration in urine, or a combination thereof. The data can describe an external body parameter such as height, weight, age, body mass index, eyesight, or another parameter of a patient's physique. Further exemplary pieces of health information comprised (e.g., contained) in text data may be medical intervention parameters such as regular medication, occasional medication, or other previous or current medical interventions and/or other information about the patient's previous and current treatments and reported health conditions. The data can comprise lifestyle information about the life of a patient, such as consumption of alcohol, smoking, and/or exercise and/or the patient's diet. The data is of course not limited to physically measurable pieces of information and may for example further comprise psychological tests and diagnoses and similar information about the mental health. The data may comprise at least parts of at least one previous opinion by a treating medical practitioner on certain aspects of the patient's health. The data may at least partly represent an electronic medical record (EMR) of a patient. An EMR can, for example, comprise information about the patient's health such as one of the different pieces of information listed in this paragraph. It is not necessary that every information in the EMR relates to the patient's body. For instance, information may for example pertain to the previous medical practitioner(s) who had contact with the patient and/or some data about the patient, assessed their health state, decided and/or carried out certain tests, operations and/or diagnoses. The EMR can comprise information about a hospital's or doctor's practice they obtained certain treatments and/or underwent certain tests and various other meta-information about the treatments, medications, tests and the body-related and/or mental-health-related information of the patient. An EMR can for example comprise (e.g. include) personal information about the patient. An EMR may also be anonymized so that the medical description of a defined, but personally un-identifiable patient is provided. In some examples, the EMR contains at least a part of the patient's medical history.

The data can also comprise one or more images. An image can for example be any one-, two-, three-or even higher dimensional arrangement of data entries that can be visualized in a way for a human observer to observe it. An image may for example be understood as a description of a spatial arrangement of points and/or the coloring, intensity and/or other properties of spatially distributed points such as, for example, pixels in a (e.g. bitmap) image or points in a three-dimensional point cloud. A non-limiting example of one-dimensional image data can be representations of test-stripes comprising multiple chemically responsive fields that indicate the presence of a chemical. Non-limiting examples of two-dimensional image data are two-dimensional images in color, black and white, and/or greyscale, diagrams, or schematic drawings. Two-dimensional images in color may be encoded in RGB, CMYK, or another color scheme. Different values of color depth and different resolutions may be possible. Two-dimensional image data can for example be acquired by a camera in the visual spectrum, the infrared spectrum or other spectral segments. Procedures such as X-ray scans can be applied and/or microscope images and various other procedures for obtaining two-dimensional image data. Non-limiting examples of three-dimensional image data are computed tomography (CT) scans, magnetic resonance imaging (MRI) scans, fluorescein angiography images, OCT (optical coherence tomography) scans, histopathological images, ultrasound images or videos comprising a sequence of two-dimensional images with the time as a third dimension. A non-limiting example of four-dimensional image data could be an ultrasound computer tomography video in which a three-dimensional scan is captured at different times to form a sequence of three-dimensional images along a fourth axis, e.g. time.

The data can be present in different modalities, such as text, numbers, images, audio and/or others.

In a preferred embodiment, the shared global model serves to generate from input data a representation of a group of patients, a single patient or a part of a patient (such as thorax, abdomen, pelvic, legs, knee, feet, arms, fingers, shoulders, an organ (e.g. heart, lungs, brain, liver, kidney, intestines, eyes, ears), blood vessels, skin and/or others).

It is for example possible that the shared global model is configured to generate from input data about a patient a representation of the patient which can be used for performing one or more tasks, e.g. diagnosis of a disease, prediction of the outcome of a certain therapy and/or the like. The feature vector generated by the shared global model can e.g. be a representation of a patient that encodes meaningful information from the EMR of the patient.

A feature vector generated by the shared global model can also be a representation of an organ of a patient. Computed tomography images, magnet resonance images, ultrasound images and/or the like can e.g. be used to generate a representation of an organ depicted in said images for performing one or more tasks such as segmentation, image analysis, identification of symptoms, and/or the like.

For illustrative purposes, a non-limiting example of an application of the present invention is given hereinafter. The example refers to the detection/diagnosis of certain lung diseases: COPD, ARDS and CTPEH.

Chronic obstructive pulmonary disease (COPD) is a type of obstructive lung disease characterized by long-term breathing problems and poor airflow. The main symptoms include shortness of breath and cough with mucus production. COPD is a progressive disease, meaning it typically worsens over time. A chest X-ray and complete blood count may be useful to exclude other conditions at the time of diagnosis. Characteristic signs on X-ray are hyperinflated lungs, a flattened diaphragm, increased retrosternal airspace, and bullae.

Acute respiratory distress syndrome (ARDS) is a type of respiratory failure characterized by rapid onset of widespread inflammation in the lungs. Symptoms include shortness of breath (dyspnea), rapid breathing (tachypnea), and bluish skin coloration (cyanosis). For those who survive, a decreased quality of life is common. The signs and symptoms of ARDS often begin within two hours of an inciting event but have been known to take as long as 1-3 days; diagnostic criteria require a known insult to have happened within 7 days of the syndrome. Signs and symptoms may include shortness of breath, fast breathing, and a low oxygen level in the blood due to abnormal ventilation. Radiologic imaging has long been a criterion for diagnosis of ARDS. Original definitions of ARDS specified that correlative chest X-ray findings were required for diagnosis, the diagnostic criteria have been expanded over time to accept CT and ultrasound findings as equally contributory. Generally, radiographic findings of fluid accumulation (pulmonary edema) affecting both lungs and unrelated to increased cardiopulmonary vascular pressure (such as in heart failure) may be suggestive of ARDS.

Chronic thromboembolic pulmonary hypertension (CTEPH) is a long-term disease caused by a blockage in the blood vessels that deliver blood from the heart to the lungs (the pulmonary arterial tree). These blockages cause increased resistance to flow in the pulmonary arterial tree which in turn leads to rise in pressure in these arteries (pulmonary hypertension). CTEPH is underdiagnosed but is the only potentially curable form of pulmonary hypertension (PH) via surgery. This is why prompt diagnosis and referral to an expert center is crucial. Imaging plays a central role in the diagnosis of CTEPH; signs of CTEPH can be identified on unenhanced computed tomography (CT), contrast-enhanced CT (CE-CT) and CT pulmonary angiography (CTPA).

In a first step, a model can be configured which generates representations of patients from input data. The input data can comprise personal data about the patients such as age, gender, weight, size, information about whether a patient is smoking, pre-existing conditions, blood pressure, and/the like as well as one or more radiological images (CT scan, X-ray image, MR san etc.) from the chest region of the patient. An encoder-decoder type neural network can be used to train the model to generate such representations from patients. The encoder is configured to receive input data and to generate a representation, the decoder is configured to reconstruct the input data from the representation. For the encoder-decoder type neural network, various backbones can be used such as the U-net (see e.g. O. Ronneberger et al .: U-net: Convolutional networks for biomedical image segmentation, in: International Conference on Medical image computing and computer-assisted intervention, pp. 234-241, Springer, 2015, https://doi.org/10.1007/978-3-319-24574-4_28) or the DenseNet (e.g. G. Huang et al .: “Densely connected convolutional networks”, IEEE Conference on Computer Vision and Pattern Recognition, 2017, pp. 2261-2269, doi: 10.1109/CVPR.2017.243.).

The reconstruction learning can be combined with a contrastive learning approach as described e.g. in: J. Dippel, S. Vogler, J. Höhne: Towards Fine-grained Visual Representations by Combining Contrastive Learning with Image Reconstruction and Attention-weighted Pooling, arXiv:2104.04323 [cs.CV] or Y. N. T. Vu et al: MedAug: Contrastive learning leveraging patient metadata improves representations for chest X-ray interpretation, arXiv:2102.10663 [cs.CV].

The model can be trained on a training set, the training set comprising patient data for a multitude of patients. Some of the patients may suffer from one of the diseases ARDS, CTEPH or COPD.

The trained model can be used as a shared global model in a federated learning environment. It can be stored on a central server. A plurality of edge devices can be set up. Each edge device can be connected to the central server so that is has access to the shared global model and receive a copy of the shared global model.

On each edge device, a task performing model can be configured which aims to perform a specific task.

There can be a first edge device for the detection of signs indicative of COPD, hereinafter referred to as COPD device. Such COPD device can e.g. be used in a doctor's office. The task performing model stored on the COPD device can be configured/trained to do a COPD classification (see e.g. J. Ahmed et al .: COPD Classification in CT Images Using a 3D Convolutional Neural Network, arXiv:2001.01100 [eess.IV]). Training data comprising, for a multitude of patients, one or more CT images of the chest region can be used for training purposes. The training data comprise patient data from patients suffering from COPD as well as patient data from patients not suffering from COPD. The patient data are inputted into the shared global model thereby receiving, for each set of patient data, a feature vector (the representation of the respective patient). The feature vector is then inputted into the task performing model which outputs a classification result for each patient.

There can be a second edge device for the detection of signs indicative of ARDS, hereinafter referred to as ARDS device. Such ARDS device can e.g. be used in an intensive care unit of a hospital. The task performing model stored on the ARDS device can be configured/trained to detect acute respiratory distress syndrome on chest radiographs (see e.g. M. W. Sjoding et al.: Deep learning to detect acute respiratory distress syndrome on chest radiographs: a retrospective study with external validation, The Lancet Digital Health, Volume 3, Issue 6, 2021, Pages e340-e348, ISSN 2589-7500). Training data comprising, for a multitude of patients, one or more chest radiographs can be used for training purposes. The training data comprise patient data from patients suffering from ARDS as well as patient data from patients not suffering from ARDS. The patient data are inputted into the shared global model thereby receiving, for each set of patient data, a feature vector (the representation of the respective patient). The feature vector is then inputted into the task performing model which outputs e.g. a probability of ARDS.

There can be a third edge device for the detection of signs indicative of CTEPH, hereinafter referred to as CTEPH device. Such CTEPH device can e.g. be used e.g. at the radiologist. It is possible to set up a CTEPH detection algorithm as a background process on a computer system which is connected to a CT scanner or part thereof. The CTEPH device can be configured to receive one or more CT scans from the chest region of a patient and detect signs indicative of CETPH. The device can be configured to issue a warning message to the radiologist, if the probability of the presence of CTEPH is above a threshold value (see e.g. WO2018202541A1, WO2020185758A1, M. Remy-Jardin et al .: Machine Learning and Deep Neural Network Applications in the Thorax: Pulmonary Embolism, Chronic Thromboembolic Pulmonary Hypertension, Aorta, and Chronic Obstructive Pulmonary Disease, J Thorac Imaging 2020, 35 Suppl 1:S40-S48). Training data comprising, for a multitude of patients, one or more CT scans can be used for training purposes. The training data comprise patient data from patients suffering from CTEPH as well as patient data from patients not suffering from CTEPH. The patient data are inputted into the shared global model thereby receiving, for each set of patient data, a probability of CTEPH.

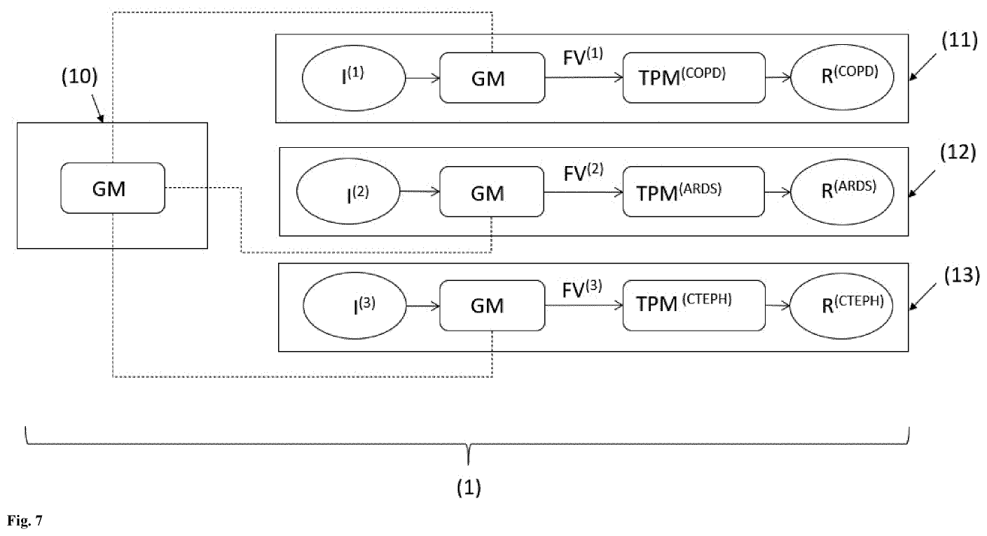

The central server, one or more COPD devices, one or more ARDS devices, one or more CTEPH devices and/or optionally further devices can be linked in a federated learning system according to the present invention. An example of such linking is shown in FIG. 7. FIG. 7 shows a federated learning system (1) comprising a central server (10), a first edge device (11), a second edge device (12), and a third edge device (13). On the central server, a global model is stored. Each edge device is connected to the central server and comprises a copy of the global model GM. If the global model is updated (e.g. during (re-)training), the edge devices can receive an updated copy of the global model. On the first edge device (11) a task performing model TPM^{(COPD)} is stored which is configured to output a classification result R^{(COPD)} on the basis of patient data I⁽¹⁾. The patient data I⁽¹⁾ are inputted into the global model (GM) thereby receiving a first feature vector FV⁽¹⁾. The feature vector FV⁽¹⁾ is inputted into the task performing model TPM^{(COPD)}, thereby receiving the classification result R^{(COPD)}. The classification result R^{(COPD)} can e.g. be displayed on a monitor and/or outputted on a printer and/or stored in a data memory. On the second edge device (12) a task performing model TPM^{(ARDS)} is stored which is configured to output a probability of ARDS R^{(ARDS)} on the basis of patient data I⁽²⁾. The patient data I⁽²⁾ are inputted into the global model (GM) thereby receiving a second feature vector FV⁽²⁾. The feature vector FV⁽²⁾ is inputted into the task performing model TPM^{(ARDS)}, thereby receiving the probability of ARDS R^{(ARDS)}. The probability value R^{(ARDS)} can e.g. be displayed on a monitor and/or outputted on a printer and/or stored in a data memory. On the third edge device (13) a task performing model TPM^{(CTEPH)} is stored which is configured to output a probability of CTEPH R^{(CTEPH)} on the basis of patient data I⁽³⁾. The patient data I⁽³⁾ are inputted into the global model (GM) thereby receiving a third feature vector FV⁽³⁾. The feature vector FV⁽³⁾ is inputted into the task performing model TPM^{(CTEPH)}, thereby receiving the probability of CTEPH R^{(CTEPH)}. The probability value R^{(CTEPH)} can e.g. be displayed on a monitor and/or outputted on a printer and/or stored in a data memory.

Once new training data is available for one or more of the edge devices, the federated learning system can be re-trained as described herein. Once a new edge device is available, it can be integrated into the federated learning system and the federated learning system comprising the new edge device can be trained as described herein.

The present invention offers a number of advantages:
Data is locally available on edge devices. Sharing (patient) data across the federation for model training etc. is not required.
Different tasks are solved at different edge devices (e.g. diagnosis of COPD, ARDS, CTEPH)
New tasks along with new data can easily be added to the training setup. The task specification and data distribution need not to be known.
Accuracy of edge-specific models will not decrease due to data in other locations. In other words, optimizing a model with local data on a specific edge device will not decrease the model's performance on data/tasks related to other edge devices.
Global knowledge is shared between different edge devices via the global model.
On edge devices: Flexibility to adapt to specific local dataset characteristics and tasks via task specific network heads. The network heads build on the global embedding and therefore implicitly can leverage knowledge and data commonalities across the entire federation for solving a local task. This can be in particular useful when data is scarce for specific tasks.
Extendible edge device functionality: New tasks specific network heads for already existing edge devices can be initialized and added to the federation at an arbitrary later time point.
Extendible Federation: New edge devices (potentially bearing new data and tasks) can be linked into the federation at an arbitrary later time point.

FIG. 8 illustrates a computing device (20) according to some example implementations of the present invention in more detail. Generally, a computing device of exemplary implementations of the present disclosure may be referred to as a computer and may comprise, include, or be embodied in one or more fixed or portable electronic devices. The computing device may include one or more of each of a number of components such as, for example, processing unit (21) connected to a memory (25) (e.g., storage device).

The processing unit (21) may be composed of one or more processors alone or in combination with one or more memories. The processing unit is generally any piece of computer hardware that is capable of processing information such as, for example, data, computer programs and/or other suitable electronic information. The processing unit is composed of a collection of electronic circuits some of which may be packaged as an integrated circuit or multiple interconnected integrated circuits (an integrated circuit at times more commonly referred to as a “chip”). The processing unit (21) may be configured to execute computer programs, which may be stored onboard the processing unit or otherwise stored in the memory (25) of the same or another computer.

The processing unit (21) may be a number of processors, a multi-core processor or some other type of processor, depending on the particular implementation. Further, the processing unit may be implemented using a number of heterogeneous processor systems in which a main processor is present with one or more secondary processors on a single chip. As another illustrative example, the processing unit may be a symmetric multi-processor system containing multiple processors of the same type. In yet another example, the processing unit may be embodied as or otherwise include one or more ASICs, FPGAs or the like. Thus, although the processing unit may be capable of executing a computer program to perform one or more functions, the processing unit of various examples may be capable of performing one or more functions without the aid of a computer program. In either instance, the processing unit may be appropriately programmed to perform functions or operations according to example implementations of the present disclosure.

The memory (25) is generally any piece of computer hardware that is capable of storing information such as, for example, data, computer programs (e.g., computer-readable program code (26)) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD, Blu-ray disk or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory (25), the processing unit (21) may also be connected to one or more interfaces (22, 23, 24, 27, 28) for displaying, transmitting and/or receiving information. The interfaces may include one or more communications interfaces (27, 28) and/or one or more user interfaces (22, 23, 24). The communications interface(s) may be configured to transmit and/or receive information, such as to and/or from other computer(s), network(s), database(s) or the like. The communications interface may be configured to transmit and/or receive information by physical (wired) and/or wireless communications links. The communications interface(s) may include interface(s) to connect to a network, such as using technologies such as cellular telephone, Wi-Fi, satellite, cable, digital subscriber line (DSL), fiber optics and the like. In some examples, the communications interface(s) may include one or more short-range communications interfaces configured to connect devices using short-range communications technologies such as NFC, RFID, Bluetooth, Bluetooth LE, ZigBee, infrared (e.g., IrDA) or the like.

The user interfaces (22, 23, 24) may include a display (24). The display (24) may be configured to present or otherwise display information to a user, suitable examples of which include a liquid crystal display (LCD), light-emitting diode display (LED), plasma display panel (PDP) or the like. The user input interface(s) (22, 23) may be wired or wireless, and may be configured to receive information from a user into the computer system (20), such as for processing, storage and/or display. Suitable examples of user input interfaces include a microphone, image or video capture device, keyboard or keypad, joystick, touch-sensitive surface (separate from or integrated into a touchscreen) or the like. In some examples, the user interfaces may include automatic identification and data capture (AIDC) technology for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions may be stored in memory, and executed by processing unit that is thereby programmed, to implement functions of the systems, subsystems, tools and their respective elements described herein. As will be appreciated, any suitable program code instructions may be loaded onto a computing device or other programmable apparatus from a computer-readable storage medium to produce a particular machine, such that the particular machine becomes a means for implementing the functions specified herein. These program code instructions may also be stored in a computer-readable storage medium that can direct a computer, processing unit or other programmable apparatus to function in a particular manner to thereby generate a particular machine or particular article of manufacture. The program code instructions may be retrieved from a computer-readable storage medium and loaded into a computer, processing unit or other programmable apparatus to configure the computer, processing unit or other programmable apparatus to execute operations to be performed on or by the computer, processing unit or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

1. A computer system comprising a plurality of edge devices, wherein:
each edge device has access to a shared global model, wherein the shared global model is configured to:
generate a feature vector based at least partially on input data provided by the edge device and on global model parameters;
each edge device comprises a task performing model which is configured to:
receive the feature vector generated by the shared global model based on the input data provided by the edge device, and
perform a task based at least partially on the feature vector and on task performing model parameters;
the computer system is configured to perform a training or a re-training, the training or re-training comprising:
receiving a new set of training data for a first edge device, the first edge device comprising a first task performing model which is configured to perform a first task based at least partially on first task performing model parameters,
training the shared global model and the first task performing model using the training data, the training comprising modifying the global model parameters and the first task performing model parameters so that a loss value calculated from a loss function is minimized, wherein the loss function is configured to:
reward modifications of the first task performing model parameters and the global model parameters which lead to an improved performance of the first task;
reward modifications of the global model parameters which lead to an improvement of the shared global model; and
penalize modifications of the global model parameters which lead to a worse performance of tasks performed by other task performing models of other edge devices of the plurality of edge devices.

2. The computer system of claim 1, wherein the computer system comprises a central server, wherein a copy of the shared global model is stored on the central server and on each edge device, wherein the central server is configured to update the shared global model on each edge device if an updated version is available.

3. The computer system of claim 1, wherein there are at least two edge devices which comprise different task performing models to perform different tasks.

4. The computer system of claim 1, wherein the tasks performed by the task performing models are selected from: classification task, regression task, data generation task, image segmentation task, reconstruction task, image quality enhancement task and/or combinations thereof.

5. The computer system of claim 1, wherein each model is or comprises a machine learning model based on an artificial neural network.

6. The computer system of claim 1, wherein the shared global model is or comprises an encoder-decoder architecture, the encoder being configured to generate a feature vector from input data and the decoder being configured to reconstruct input data from a feature vector.

7. The computer system claim 1, wherein a consistency data set is stored on each edge device, wherein each consistency data set comprises consistency input data and consistency target data, wherein the training or re-training comprises:
computing a first loss value L⁽¹⁾, the first loss value L⁽¹⁾ quantifying the impact of modifications of the global model parameters and of the first task performing model parameters on the performance of the first task;
computing a feature generation loss value L^{GM}, the feature generation loss value L^{GM} quantifying the impact of modifications of the global model parameters on the quality of the feature vector generation, wherein the shared global model is set up as an encoder-decoder, wherein the encoder is configured to receive input data and generate, at least partially on the basis of the global model parameters, a feature vector from the input data, and the decoder is configured to reconstruct, at least partially on the basis of the global model parameters, the input data from the feature vector, wherein the quality of the feature vector generation is quantified by computing a reconstruction loss;
for each edge device E^{(j)} other than the first edge device:
inputting the consistency input data into the shared global model,
receiving from the shared global model a feature vector,
inputting the feature vector into the task performing model stored on the edge device,
receiving a result from the task performing model, and
computing, at least partially on the basis of the received result and the consistency target data, a consistency loss L^{(j)}, the consistency loss quantifying the impact of modifications of the global model parameters on the deviations between the result and the consistency target;
computing a total loss value L from the feature generation loss value L^{GM}, the first loss value L⁽¹⁾ and all consistency losses L^{(j)}; and
modifying the global model parameters and the first task performing model parameters so that the total loss value L is minimized.

8. The computer system of claim 1, wherein the input data and the training data are medical data of one or more patients.

9. The computer system of claim 1, wherein one or more tasks performed by one or more task performing models of one or more edge devices comprises the detection of signs indicative of one or more diseases.

10. The computer system of claim 1, wherein the one or more diseases is/are: CTEPH, ARDS and/or COPD.

11. A computer-implemented method of training or re-training a federated learning system, the method comprising:
providing a federated learning system comprising at least two edge devices, a first edge device and a second edge device, wherein:
the first edge device and the second edge device have access to a shared global model, wherein the shared global model is configured to generate a feature vector based at least partially on input data provided by the first edge device or the second edge device and global model parameters,
the first edge device comprises a first task performing model, wherein the first task performing model is configured to perform a first task based at least partially on the feature vector generated by the shared global model based on the input data provided by the first edge device and on first task performing model parameters, and
the second edge device comprises a second task performing model, wherein the second task performing model is configured to perform a second task based at least partially on the basis of the feature vector generated by the shared global model based on input data provided by the second edge device and on second task performing model parameters;
training or re-training of the federated learning system, wherein the training or re-training comprises:
inputting first input data into the shared global model and receiving a first feature vector,
inputting the first feature vector into the first task performing model and receiving a first task result,
inputting second input data into the shared global model, and receiving a second feature vector,
inputting the second feature vector into the second task performing model and receiving a second task result,
calculating a loss value by using a loss function, wherein the loss function is configured to:
reward modifications of the first task performing model parameters and the global model parameters which lead to an improved performance of the first task,
reward modifications of the global model parameters which lead to an improvement of the shared global model, and
penalize modifications of the global model parameters which lead to a worse performance of the second task,
modifying the first task performing model parameters and the global model parameters, based, at least partially, on minimizing the loss value.

12. The method of claim 11, wherein the first task performance model is configured to perform a different task than the second task performing model.

13. The method of claim 11, wherein a consistency data set is stored on the second edge device, the consistency data set comprising consistency input data and consistency target data, wherein the training or re-training comprises the following steps:
receiving new training data for the first edge device, the new training data comprising first input data and first target data,
inputting the first input data into the shared global model, and receiving a first feature vector,
inputting the first feature vector into the first task performing model and receiving a first task result,
calculating a first loss value, the first loss value quantifying the deviations between the first task result and the first target data,
inputting the consistency input data into the shared global model, and receiving a second feature vector,
inputting the second feature vector into the second task performing model and receiving a second task result,
calculating a second loss value, the second loss value quantifying the deviations between the second task result and the consistency target data,
reconstructing the first input data from the first feature vector using the shared global model,
calculating a third loss value, the third loss value quantifying the deviations between the first input data and the reconstructed first input data,
calculating a total loss value on the basis of the first loss value, the second loss value and the third loss value, and
modifying the first task performing model parameters and the global model parameters, based, at least partially, on minimizing the total loss value.

14. A non-transitory computer-readable storage medium comprising processor-executable instructions with which to perform an operation for training or re-training a federated learning system, the federated learning system comprising at least two edge devices, a first edge device and a second edge device, wherein:
the first edge device and the second edge device have access to a shared global model, wherein the shared global model is configured to generate a feature vector based at least partially on input data provided by the first edge device or by the second edge device and on global model parameters,
the first edge device comprises a first task performing model, wherein the first task performing model is configured to perform a first task based at least partially on the feature vector generated by the shared global model on the basis of the based on input data provided by the first edge device and on first task performing model parameters, and
the second edge device comprises a second task performing model, wherein the second task performing model is configured to perform a second task based at least partially on the basis of the feature vector generated by the shared global model based on the input data provided by the second edge device and on second task performing model parameters,
wherein the operation comprises:
inputting first input data into the shared global model, and receiving a first feature vector,
inputting the first feature vector into the first task performing model and receiving a first task result,
inputting second input data into the shared global model, and receiving a second feature vector,
inputting the second feature vector into the second task performing model and receiving a second task result,
calculating a loss value by using a loss function, wherein the loss function is configured to:
reward modifications of the first task performing model parameters and the global model parameters which lead to an improved performance of the first task, and
reward modifications of the global model parameters which lead to an improvement of the shared global model, and
penalize modifications of the global model parameters which lead to a worse performance of the second task,
modifying the first task performing model parameters and the global model parameters, based, at least partially, on minimizing the loss value.

15. The computer system of claim 1, wherein the computer system is configured for medical use, in particular for performing tasks on medical data of patients.
